(19) United States
(12) Patent Application Publication
(10) Pub. No.: US 2024/0362105 A1
(43) Pub. Date: Oct. 31, 2024

(54) Machine Learning/Deep Learning Engines Used to Determine Path Root Cause of Failures

(71) Applicant: Dell Products L.P., Round Rock, TX (US)

(72) Inventors: Michael Barnes, Doylestown, PA (US); Sumanta Kashyapi, Worcester, MA (US); Zachary W. Arnold, Royal Oak, MI (US); Wenjin Liu, Cary, NC (US)

(73) Assignee: Dell Products L.P., Round Rock, TX (US)

(21) Appl. No.: 18/140,053

(22) Filed: Apr. 27, 2023

(51) Int. Cl. G06F 11/07; G06F 11/34

(52) U.S. Cl. CPC G06F 11/079; G06F 11/3447

(57) ABSTRACT

A system, method, and computer-readable medium for determining a root cause for a failure event. A failure of a product or system triggers a failure event. When the failure event is triggered, querying by one or more ML/DL path root cause engines is performed on stored failure incident data sets. The queried failure incident data sets are listed and ranked. Based on the ranking, a root cause is determined as to the failure event.

### BACKGROUND OF THE INVENTION

### Field of the Invention

The present invention relates to product support services. More specifically, embodiments of the invention provide a system, method, and computer-readable medium for supporting path root causes of product failures using deep learning engines.

### Description of the Related Art

Products, such as computer hardware (e.g., laptop computers, network servers, data storage, power supplies, etc.), software, and integrated systems, can fail due to different issues. Providers of such products support their customers by identifying and providing solutions to address such failures.

Failure analysis is a systematic process used to determine reasons a product, system, or process fails. Failure analysis includes finding correct solutions to address particular failures. To find such solutions, incidents of product failures can be collected and analyzed. Such incidents can include particular patterns and solutions. It would be beneficial to be able to make use of failure data and incidents to support customers when their products fail and provide solutions to address the product failure.

### SUMMARY OF THE INVENTION

A computer-implementable method, system and computer-readable storage medium for determining a root cause for a failure event comprising receiving the failure event; querying by one or more ML/DL path root cause engines using vectorized time series signatures, failure incident data sets as to the failure event, wherein the querying is triggered by the receiving the failure event; listing the queried failure incident data sets; ranking a list of the queried failure incident data sets; and providing the root cause of the failure event based on the ranking.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 is a general illustration of a system to generate failure incident data sets;

FIG. 2 is a general illustration of a system to rank incident data sets and provide a root cause solution for a failure event;

FIG. 3 is a generalized flowchart for determining a root cause for a failure event; and

FIG. 4 is general illustration of components of an information handling system as implemented in the present invention;

### DETAILED DESCRIPTION

Product data can be received from various sources, including platforms and services (e.g., cloud services) that provide product support and gather metric time series product data (i.e., data changing over time), and product configuration. In various implementations machine/deep learning (ML/DL) models implemented as anomaly detector(s) identify problems or anomalies in data that change over time (i.e., time series). Data unavailable/data loss (DU/DL) detector(s) determine if there is something wrong with the data that is received. A natural language engine(s) can receive text based files, such as service repair tickets, solution recommendation inputs from subject matter experts (SME). A time series failure incident data set can be generated from processed data from anomaly detector(s), DU/DL detectors, and the natural language engine(s). Time series failure incident data sets are categorized and can be stored in a failure data catalog or database.

When a failure occurs in a product or failure event occurs, one or more ML/DL engines query the failure data catalog to select the closest failure incident data sets to the failure event. The one or more ML/DL engines are considered as path root cause rules engines, and in certain implementations can include different classes or types of models are further described. Ranking can be performed as to the closest failure incident data sets recommended by the ML/DL engines. When two or more ML/DL engines are implemented, ranking can be consolidated.

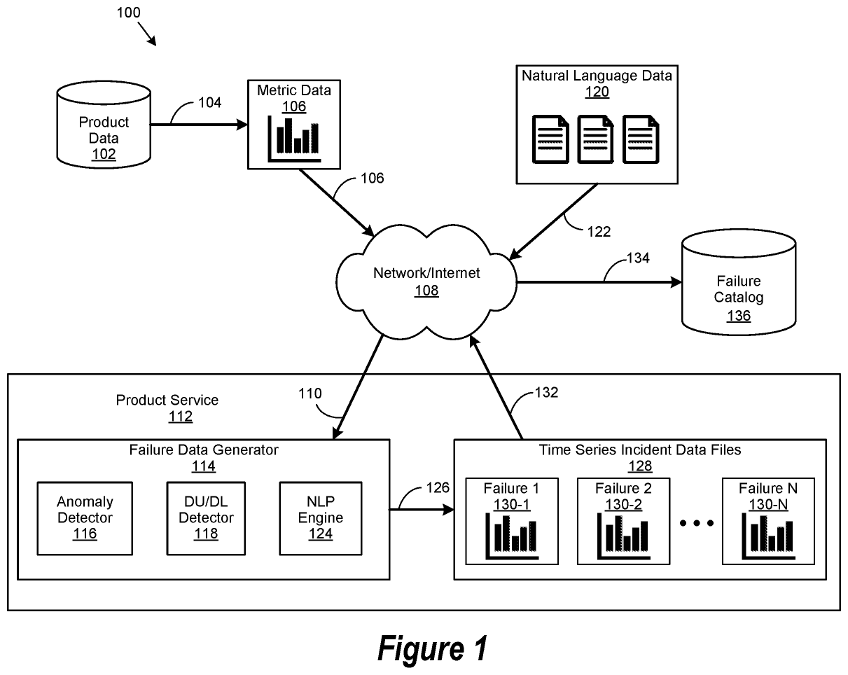

FIG. 1 shows a system to generate failure incident data sets. The system 100 includes product data 102 which can be from various sources including platforms and services (e.g., cloud services) that provide product support and gather metric time series product data (i.e., data changing over time), and time series product configuration. Product data can be related to products such as data storage, computer server systems, power supply systems, etc.

Product telemetry 104 provides metric data 106. Implementations provide for product telemetry 104 to include networks such as network 108, where network 108 can include one or more wired and wireless networks, including the Internet. Product data 102 is measured in time domain, or in other words in time series. For example, product data 102 can be monitored for ten time series metrics.

The time series metric data 106 is sent 110 to the network 108, and received by product service 112. Product service 112 can be implemented as a cloud computing service, as one or more information handling systems, etc. Implementations provide for the product service 112 to include a failure data generator 114. Failure data generator 114 can be configured to generate time series failure incident data sets which are further described herein.

The failure data generator 114 can include one or more ML/DL engines configured as an anomaly detector 116, which detects failures in the product/system. In particular, time series metric data 106 is received by anomaly detector 116 which detects product/system failures in the time series metric data 106.

The failure data generator 114 can include a data unavailable/data loss (DU/DL) predictor 118 which also receives the time series metric data 106. The DU/DL predictor 118 is configured in certain instances to determine/predict if data in the time series metric data 106 is wrong, missing, or lost. In other instances, metric data 106 is available during a DU/DL event where an anomaly in the metric data is detected to determine that the system is experiencing a DU/DL event. The root cause of the issue is found from the specific pattern in the metric data. DU/DL events can be specific types of failures of systems (e.g., storage) where the effect is mostly the same from a user perspective (data loss/unavailable), but there are several possible root causes.

Implementations provide for the system 100 to include natural language data files (e.g., text files) 120, which can include data files related to the product/system of the time series data 106. The data files of natural language data 120 can include service repair tickets, input from subject matter experts (SME), etc., and can include repair, solution, resolution as to failures related to the product/system. In certain implementations, the data files of natural language data 120 are provided from the platforms and services (e.g., cloud services) that provide product support described above.

The data files of natural language data 120 are sent 122 and received 110 by product service 112/failure data generator 114. The failure data generator 114 can include a natural language processing (NLP) engine 124 that receives and processes the data files of natural language data 120, and associates the data files with time series metric data 106 processed by the anomaly detector 116 and DU/DL predictor 118.

The failure data generator 114 and particularly anomaly detector 116, DU/DL predictor 118, and NLP engine 124 generates 126 time series failure incident data set 128. Time series failure incident data sets 128 include multiple failure incident data sets 130-1 to 130-N. The failure incident data sets 130 include time series data signatures (e.g., several days of univariate/multivariate metric data) with a corresponding identifier (i.e., failure mechanism). In certain implementations, the failure incident data sets 130 can include additional categorical features.

The failure incident data sets 130 are sent 132 to and received 134 by a failure data catalog 136. The failure data catalog 136 can be implemented as various data stores, including cloud storage, data lakes, etc. Failure incident data sets 130 can be stored in particular units of the failure data catalog 136, such as data store buckets.

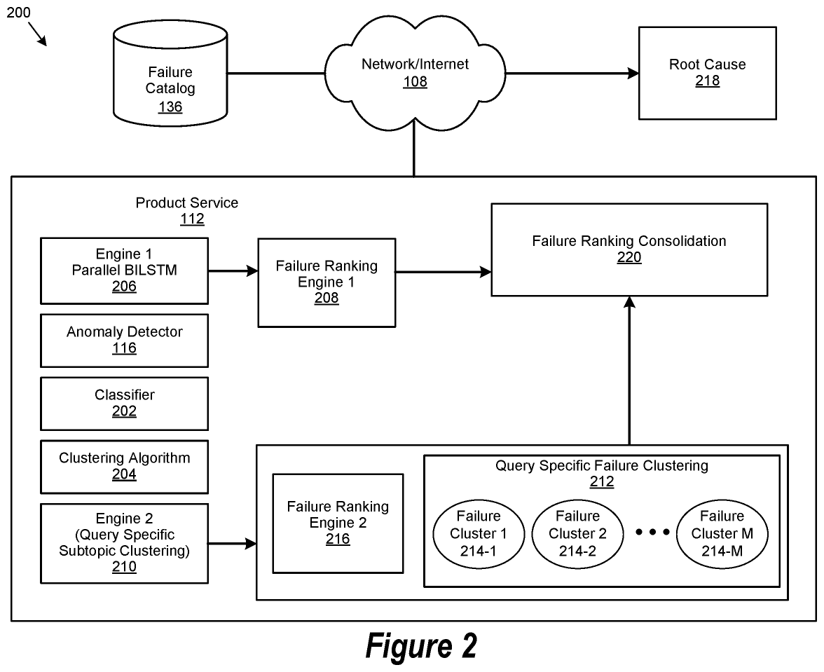

FIG. 2 shows a system 200 to rank failure incident data sets 130 and provide a root cause solution for a failure event. The system 200 includes the previously described product service 112. When a failure takes place, such as a detected or reported failure of a product/system of a customer, a failure event occurs. The failure can be received from platforms and services (e.g., cloud services) that provide product support as described above. In certain implementations, the failure event triggers a failure query at the product service 112.

Implementations provide for the anomaly detector 116, a classifier 202, or clustering algorithm 204 to indicate the failure query to the failure data catalog 136. In particular, implementations provide for one or more ML/DL path root cause engines that performing queries as to failure incident data sets 130 of the failure data catalog 136 that match the received failure event. The ML/DL path root cause engines are similar to models used for natural language questioning and answering; however, instead of vectorized NLP words, time series data signatures are used.

In the example, an engine 1 206 can be implemented as a parallel biLSTM (Bidirectional long short-term memory) with multi-head attention model. It is to be understood that other ML/DL models can be used such as convolutional neural networks (CNN), and other complete attention models including Bidirectional Encoder Representations from Transformers (BERT). Whatever model is implemented, the model is able to use vectorized time series signatures in querying the failure incident data sets 130 of failure catalog 136.

Querying failure incident data sets 130 of failure catalog 136 by engine 1 206 results in a ranked list 208 of failure incident data sets 130 matching the received failure event.

In this example, another ML/DL path root cause engine is implemented, which uses vectorized time series signatures in querying the failure incident data sets 130 of failure catalog 136. Implementations provide for engine 2 210 to be a query-specific subtopic clustering model that compartmentalizes failure incident data sets 130 sets as represented by query specific failure clustering 212. The clusters of the failure data sets 130 are represented as failure clusters 214-1 to 214-M. The engine 2 210 can use deep learning transformers in conjunction with clustering techniques based on rules or queries. Ranking of root causes from the clusters generated by the engine 2 210 can make use of Natural Language Processing (NLP) or Information Retrieval (IR) domain, where ranking is performed using clusters. A neural ranking model can be trained on clustering representations generated by query specific clusters.

Querying failure incident data sets 130 of failure catalog 136 by engine 2 210 results in a ranked list 216 of failure incident data sets 130 matching the received failure event.

If only one of the ML/DL path root cause engine is implemented, a root cause 218 for the received failure event is provided based on the ranked lists 208 or 216. The root cause 218 can be based on the highest ranked failure incident data set 130 of either ranked lists 208 or 216. The root cause 218 can be provided as a solution, repair, or resolution of the received failure event.

For implementations using two or more ML/DL path root cause engines, such as both engine 1 206 and engine 2 208, failure ranking consolidation 220 can be implemented. The failure ranking consolidation 220 receives the ranked lists 208 and 216 and determines a consolidated ranked list of failure incident data sets 130. Examples of algorithms that can be implemented failure ranking consolidation 220 include learning to rank (LTR) techniques applied to supervised machine learning to solve ranking problems in search relevancy.

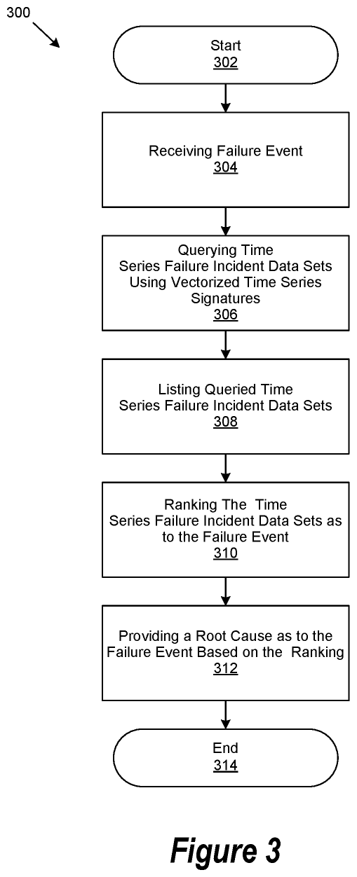

FIG. 3 is a generalized flowchart 300 for determining a root cause for a failure event. The order in which the method is described is not intended to be construed as a limitation, and any number of the described method steps may be combined in any order to implement the method, or alternate method. Additionally, individual steps may be deleted from the method without departing from the spirit and scope of the subject matter described herein. Furthermore, the method may be implemented in any suitable hardware, software, firmware, or a combination thereof, without departing from the scope of the invention.

At step 302 the process 300 starts. At step 304, a failure event is received. The failure event can occur from a detected or reported failure of a product/system of a customer. The failure can be received from platforms and services (e.g., cloud services) that provide product support.

At step 306, the failure event triggers a query by one or more ML/DL path root cause engines. Querying by the one or more ML/DL path root cause engines is performed on failure incident data sets 130 of the failure data catalog 136 based on the failure event. The one or more ML/DL path root cause engines use time series data signatures in the querying.

At step 308, listing of the failure incident data sets 130 is performed by the one or more ML/DL path root cause engines.

At step 310, ranking of the list of failure incident data sets 130 is performed by the one or more ML/DL path root cause engines.

At step 312, the root cause for the failure event is provided based on the ranking of the failure incident data sets 130. For example, the top ranked failure incident data set 130 is provided as the root cause for the failure event. At step 312, the process 300 ends.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a microphone, keyboard, a video display, a mouse, etc. The information handling system may also include one or more buses operable to transmit communications between the various hardware components.

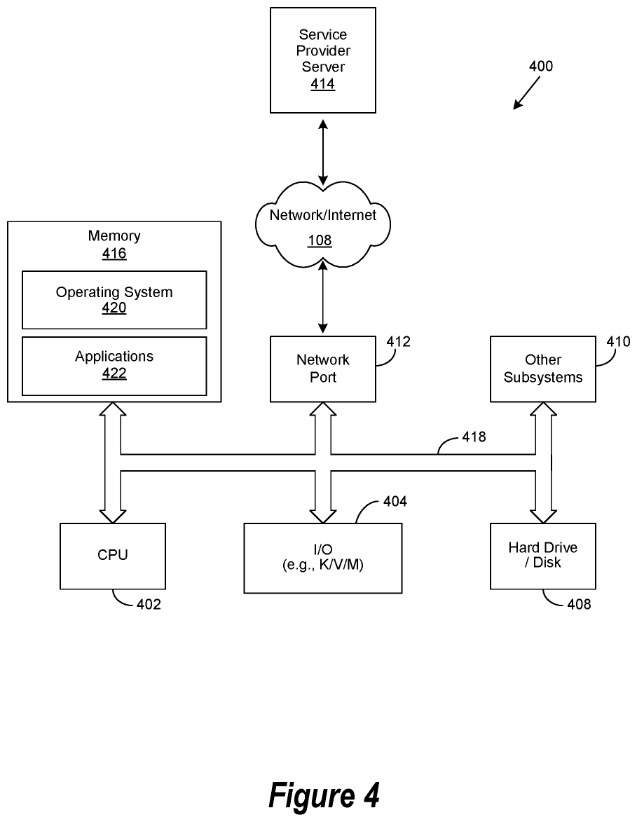

FIG. 4 is a generalized illustration of an information handling system 400 that can be used to implement the system and method of the present invention. The information handling system 400 can be implemented as a computing device, such as a network server, or multiple servers supporting a service, such as product service 112. The information handling system 400 can also be computing devices of a cloud service that supports a service, such as product service 112.

The information handling system 400 includes a processor (e.g., central processor unit or “CPU”) 402, input/output (I/O) devices 404, such as a microphone, a keyboard, a video/display, a mouse, and associated controllers (e.g., K/V/M).

The information handling system 400 includes a hard drive or disk storage 408, and various other subsystems 410. In various embodiments, the information handling system 400 also includes network port 412 operable to connect to the network 108 described herein, where network 108 can include one or more wired and wireless networks, including the Internet. Network 108 is likewise accessible by a service provider server 414.

The information handling system 400 likewise includes system memory 416, which is interconnected to the foregoing via one or more buses 418. System memory 416 can be implemented as hardware, firmware, software, or a combination of such. System memory 416 further includes an operating system (OS) 420. Embodiments provide for the system memory 416 to include applications 422.

As will be appreciated by one skilled in the art, the present invention may be embodied as a method, system, or computer program product. Accordingly, embodiments of the invention may be implemented entirely in hardware, entirely in software (including firmware, resident software, micro-code, etc.) or in an embodiment combining software and hardware. These various embodiments may all generally be referred to herein as a “circuit,” “module,” or “system.” Furthermore, the present invention may take the form of a computer program product on a computer-usable storage medium having computer-usable program code embodied in the medium.

Any suitable computer usable or computer readable medium may be utilized. The computer-usable or computer-readable medium may be, for example, but not limited to, an electronic, magnetic, optical, electromagnetic, infrared, or semiconductor system, apparatus, or device. More specific examples (a non-exhaustive list) of the computer-readable medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, or a magnetic storage device. In the context of this document, a computer-usable or computer-readable medium may be any medium that can contain, store, communicate, or transport the program for use by or in connection with the instruction execution system, apparatus, or device.

Computer program code for carrying out operations of the present invention may be written in an object-oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

Embodiments of the invention are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only and are not exhaustive of the scope of the invention.

Skilled practitioners of the art will recognize that many such embodiments are possible, and the foregoing is not intended to limit the spirit, scope or intent of the invention. Consequently, the invention is intended to be limited only by the spirit and scope of the appended claims, giving full cognizance to equivalents in all respects.

What is claimed is:

1. A computer-implementable method for determining a root cause for a failure event comprising:
receiving the failure event;
querying by one or more ML/DL path root cause engines using vectorized time series signatures, failure incident data sets as to the failure event, wherein the querying is triggered by the receiving the failure event;
listing the queried failure incident data sets;
ranking a list of the queried failure incident data sets; and
providing the root cause of the failure event based on the ranking.

2. The method of claim 1, wherein receiving the failure event is from a platform or service that monitors products and systems.

3. The method of claim 1, wherein the querying is performed by an anomaly detector, classifier, or clustering algorithm.

4. The method of claim 1, wherein the one or more ML/DL path root cause engines include biLSTM model, convolutional neural networks, Bidirectional Encoder Representations from Transformers, and query-specific subtopic clustering model.

5. The method of claim 1, wherein at least two ML/DL path root cause engines are implemented.

6. The method of claim 5, wherein each ML/DL path root cause engine performs ranking, and ranking consolidation is performed on rankings of the ML/DL path root cause engines.

7. The method of claim 1, wherein deep learning transformers are used when one of the ML/DL path root cause engines is a query-specific clustering model.

8. A system comprising:
a processor;
a data bus coupled to the processor; and
a non-transitory, computer-readable storage medium embodying computer program code, the non-transitory, computer-readable storage medium being coupled to the data bus, the computer program code interacting with a plurality of computer operations determining a root cause for a failure event executable by the processor and configured for:
receiving the failure event;
querying by one or more ML/DL path root cause engines using vectorized time series signatures, failure incident data sets as to the failure event, wherein the querying is triggered by the receiving the failure event;
listing the queried failure incident data sets;
ranking a list of the queried failure incident data sets; and
providing the root cause of the failure event based on the ranking.

9. The system of claim 8, wherein receiving the failure event is from a platform or service that monitors products and systems.

10. The system of claim 8, wherein the querying is performed by an anomaly detector, classifier, or clustering algorithm.

11. The system of claim 8, wherein the one or more ML/DL path root cause engines include biLSTM model, convolutional neural networks, Bidirectional Encoder Representations from Transformers, and query-specific subtopic clustering model.

12. The system of claim 8, wherein at least two ML/DL path root cause engines are implemented.

13. The system of claim 12, wherein each ML/DL path root cause engine performs ranking, and ranking consolidation is performed on rankings of the ML/DL path root cause engines.

14. The system of claim 8, wherein deep learning transformers are used when one of the ML/DL path root cause engines is a query-specific clustering model.

15. A non-transitory, computer-readable storage medium embodying computer program code for determining a root cause for a failure event, the computer program code comprising computer executable instructions configured for:
receiving the failure event;
querying by one or more ML/DL path root cause engines using vectorized time series signatures, failure incident data sets as to the failure event, wherein the querying is triggered by the receiving the failure event;
listing the queried failure incident data sets;
ranking a list of the queried failure incident data sets; and
providing the root cause of the failure event based on the ranking.

16. The non-transitory, computer-readable storage medium of claim 15, wherein receiving the failure event is from a platform or service that monitors products and systems.

17. The non-transitory, computer-readable storage medium of claim 15, wherein the querying is performed by an anomaly detector, classifier, or clustering algorithm.

18. The non-transitory, computer-readable storage medium of claim 15, wherein the one or more ML/DL path root cause engines include biLSTM model, convolutional neural networks, Bidirectional Encoder Representations from Transformers, and query-specific subtopic clustering model.

19. The non-transitory, computer-readable storage medium of claim 15, wherein at least two ML/DL path root cause engines are implemented.

20. The non-transitory, computer-readable storage medium of claim 19, wherein each ML/DL path root cause engine performs ranking, and ranking consolidation is performed on rankings of the ML/DL path root cause engines.
